(19) United States
(12) Patent Application Publication
(10) Pub. No.: US 2022/0008850 A1
(43) Pub. Date: Jan. 13, 2022

(54) SUPER-ABSORBENT FILTER CAPABLE OF RAPIDLY AND ECONOMICALLY REMOVING MOISTURE IN LUBRICANT

(71) Applicant: Solge Corp., Daegu (KR)

(72) Inventors: Tae Heon Kim, Daegu (KR); Hyung-Gyu Park, Daegu (KR)

(21) Appl. No.: 17/346,890

(22) Filed: Jun. 14, 2021

(30) Foreign Application Priority Data
Jul. 8, 2020 (KR) 10-2020-0084395

(51) Int. Cl. B01D 39/16

(52) U.S. Cl. CPC B01D 39/1623; B01D 2239/0618; B01D 2275/20; B01D 2257/80; B01D 2239/065

(57) ABSTRACT

Proposed is a super-absorbent filter capable of rapidly and economically removing moisture in a lubricant. More particularly, the super-absorbent filter includes: a filter body formed in a cylindrical shape by using a super-absorbent material so as to adsorb and remove free moisture in oil; and a particle filter capable of capturing contaminated particles in oil by using an internal particle filter and an external particle filter that are respectively added and sewed to an internal portion and an external portion of the filter body formed in the cylindrical shape. By using the super-absorbent filter proposed in the present disclosure, preventing of loosening of the filter body that may be caused by moisture adsorption of the super-absorbent material and blocking contaminated particles in oil by assisting a core filter installed inside the super-absorbent filter are possible.

### CROSS-REFERENCE TO RELATED APPLICATION

The present application claims priority to Korean Patent Application No. 10-2020-0084395, filed Jul. 8, 2020, the entire contents of which is incorporated herein for all purposes by this reference.

### BACKGROUND OF THE INVENTION

### Field of the Invention

The present disclosure relates to a super-absorbent filter capable of rapidly and economically removing moisture in a lubricant. More particularly, the present disclosure relates to a super-absorbent filter capable of rapidly and economically removing moisture in a lubricant by using a filter formed in a cylindrical shape, the filter being made of a super-absorbent material that is added to an internal portion and an external portion of a filter body, so that free moisture accidentally flowing in a lubricant system of a power plant facility can be removed in a short period of time.

### Description of the Related Art

Generally, a lubricant is oil used to reduce frictional force generated on a friction surface of a machine, or used to dissipate frictional heat generated on the friction surface. A turbine oil used as the lubricant is used by being circulated in facility in various industrial fields. At this time, air that flows into the facility system used in various industrial fields includes many of contaminated particles and much moisture, and the moisture as a main contaminant flowing in from outside is a main problem when a power plant is constructed, assembled, or commissioned. However, in a turbine lubrication system being operated in a stable condition, a risk of the problem decreases, but it can be a big problem when air is accidentally introduced into the turbine lubrication system. Such moisture causes a critical breakdown of the facility, and causes the lifespan of the lubricant to be quickly reduced.

As such, in a turbine of a power plant facility, the integrity of a lubricant in the turbine system is important for stable operation of the turbine, and the integrity of the lubricant is a major factor in determining an operation reliability of the power plant facility. At this time, looking at an effect of moisture on the operation reliability of the turbine for a power plant facility, the moisture is a cause of shortening the life of a bearing, promoting an oxidation of the lubricant, causing loss of the lubricant oil additive, and causing corrosion of a facility.

In this case, the moisture as the main contaminant flowing in from outside is primary problem when the power plant is constructed, assembled, or commissioned. However, in the turbine lubrication system being operated in the stable condition, the risk for the problem decreases. However, the moisture accidentally introduced in the facility can be the big problem. Especially, when the moisture accidentally introduced in the facility is not removed in a short period of time, a performance degradation of the power plant facility as mentioned above is caused, and there is a problem that a lot of time, manpower, and cost are required due to maintenance of reduced operation reliability of the facility and frequent breakdown of the facility.

### SUMMARY OF THE INVENTION

Accordingly, the present disclosure has been made keeping in mind the above problems occurring in the related art, and an objective of the present disclosure is to provide a super-absorbent filter capable of rapidly removing free moisture accidentally introduced into a lubrication system of a power plant facility in a short period of time, in which the super-absorbent filter capable of rapidly and economically removing moisture in a lubricant has a configuration including: a filter body formed in a cylindrical shape by using a super-absorbent material so as to adsorb and remove free moisture in oil; and a particle filter including an internal particle filter and an external particle filter that are respectively added and sewed to an internal portion and an external portion of the super-absorbent material so that preventing of loosening of the filter body that may be caused by moisture adsorption of the super-absorbent material and blocking contaminated particles in oil by assisting a core filter installed inside the super-absorbent filter are possible.

In addition, another objective of the present disclosure is to provide a super-absorbent filter capable of facilitating attachment and detachment of the super-absorbent filter applied to the power plant facility by using a handle so that the workability and efficiency may be further improved, wherein the super-absorbent filter has a configuration including: the particle filter provided with the internal particle filter and the external particle filter that are respectively added and sewed to the internal portion and the external portion of the filter body formed in the cylindrical shape; and the handle formed on the filter body.

In addition, a still another objective of the present disclosure is to provide a super-absorbent filter that has a configuration including: the filter body formed in the cylindrical shape by using the super-absorbent material; the particle filter capable of preventing loosening of the filter body that may be caused by moisture adsorption of the super-absorbent material and capable of blocking contaminated particles in oil by assisting a core filter installed inside the super-absorbent filter; and the sock-type moisture-adsorption-type moisture filter including the handle, and to provide a super-absorbent filter capable of immediately applicable to the power plant facility, and the convenience of use may be further improved with a simple operation accordingly since the super-absorbent filter is used by covering outside the existing standard particle filter used in the power plant facility.

In order to achieve the objectives of the present disclosure, A super-absorbent filter capable of rapidly and economically removing moisture in a lubricant, the super-absorbent filter includes: a filter body formed in a cylindrical shape by using a super-absorbent material so as to adsorb and remove free moisture in oil; and a particle filter including an internal particle filter and an external particle filter that are respectively added and sewed to an internal portion and an external portion of the filter body that is formed in the cylindrical shape, the particle filter being configured to prevent loosening of the filter body that may be caused by moisture adsorption of the super-absorbent material and to block contaminated particles in the oil by assisting a core filter installed inside the super-absorbent filter.

Preferably, the filter body may be formed in the cylindrical shape by using the super-absorbent material, and may be configured in a structure in which an upper portion and a lower portion thereof are opened.

Preferably, the filter body may be formed of a super-absorbent nonwoven-fabric material that is to remove free moisture in the oil.

Preferably, the filter body may function to allow the super-absorbent filter to be immediately applicable, without a need for an additional module housing, to a power plant facility that uses an existing standard particle filter as the core filter since the filter body is used by covering outside the existing standard particle filter.

More preferably, the particle filter may be formed by being respectively added and sewed to the internal portion and the external portion of the filter body formed in the cylindrical shape, and may be configured to prevent loosening of the filter body that may be caused by the moisture adsorption of the super-absorbent material and to have a pore size capable of blocking the contaminated particles in the oil.

More particularly, the super-absorbent filter for removing free moisture in the oil may function as a sock-type moisture-adsorption-type moisture filter.

Even more particularly, the super-absorbent filter for removing free moisture in the oil may further include a handle applied to any one of an upper portion and a lower portion of the filter body having the cylindrical shape.

Even more particularly, the handle may function to facilitate attachment and detachment of the super-absorbent filter when the super-absorbent filter is used in the power plant facility in which the super-absorbent filter is applied in a state of covering outside the existing standard particle filter.

According to the present disclosure, the super-absorbent filter capable of rapidly and economically removing moisture in a lubricant has a configuration including: the filter body formed in the cylindrical shape by using the super-absorbent material so as to adsorb and remove free moisture in oil; and the particle filter including the internal particle filter and the external particle filter that are respectively added and sewed to the internal portion and the external portion of the super-absorbent material so that preventing of loosening of the filter body that may be caused by moisture adsorption of the super-absorbent material and blocking contaminated particles in oil by assisting a core filter installed inside the super-absorbent filter are possible. Therefore, free moisture accidentally introduced into a lubrication system of a power plant facility may be rapidly removed in a short period of time.

In addition, according to the present disclosure, the super-absorbent filter has a configuration including: the particle filter provided with the internal particle filter and the external particle filter that are respectively added and sewed to the internal portion and the external portion of the filter body formed in the cylindrical shape; and the handle formed on the filter body. Therefore, attachment and detachment of the super-absorbent filter applied to the power plant facility is facilitated by using the handle, and the workability and efficiency may be further improved accordingly.

In addition, according to the present disclosure, the super-absorbent filter has a configuration including: the filter body formed in the cylindrical shape by using the super-absorbent material; the particle filter capable of preventing of loosening of the filter body that may be caused by moisture adsorption of the super-absorbent material and capable of blocking contaminated particles in oil by assisting a core filter installed inside the super-absorbent filter; and the sock-type moisture-adsorption-type moisture filter including the handle. Therefore, since the super-absorbent filter is used by covering outside the existing standard particle filter, the super-absorbent filter may be immediately applicable, without a need for a separate additional module housing, to a facility, and the convenience of use may be further improved with a simple operation accordingly.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a functional block diagram illustrating a configuration of a super-absorbent filter capable of rapidly and economically removing moisture in a lubricant according to an embodiment of the present disclosure;

FIG. 2 is a functional block diagram illustrating a configuration of a particle filter of the super-absorbent filter capable of rapidly and economically removing moisture in a lubricant according to an embodiment of the present disclosure;

FIG. 3 is a schematic sectional view illustrating the configuration of the super-absorbent filter capable of rapidly and economically removing moisture in a lubricant according to an embodiment of the present disclosure;

FIG. 4 is a schematic perspective view illustrating the configuration of the super-absorbent filter capable of rapidly and economically removing moisture in a lubricant according to an embodiment of the present disclosure;

FIG. 5 is a schematic perspective view illustrating an existing standard particle filter to be covered with the super-absorbent filter capable of rapidly and economically removing moisture in a lubricant according to an embodiment of the present disclosure;

FIG. 6 is a view illustrating a process of covering the existing standard particle filter with the super-absorbent filter capable of rapidly and economically removing moisture in a lubricant according to an embodiment of the present disclosure;

FIG. 7 is a view illustrating a combined state in which the existing standard particle filter is covered with the super-absorbent filter capable of rapidly and economically removing moisture in a lubricant according to an embodiment of the present disclosure; and

FIG. 8 shows a procedure of a moisture absorption test of a super-absorbent material that is used as a filter body of the super-absorbent filter capable of rapidly and economically removing moisture in a lubricant according to an embodiment of the present disclosure.

### DESCRIPTION OF THE PREFERRED EMBODIMENTS

Hereinafter, a preferred embodiment will be described in detail with reference to the accompanying drawings so that a person having ordinary knowledge in the art can easily implement the present disclosure. However, in describing the preferred embodiment of the present disclosure in detail, if it is determined that a detailed description of a related known function or configuration may unnecessarily obscure the subject matter of the present disclosure, the detailed description thereof will be omitted. In addition, the same reference numerals are used throughout the drawings for components having similar functions and operations.

Moreover, throughout the present specification, when it is stated that a part is “connected” with another part, this includes not only cases where the parts are “directly connected” with each other, but also cases where the parts are “indirectly connected” with each other through a member interposed therebetween. Also, when a part “includes” or “comprises” an element, unless there is a particular description contrary thereto, the part may further include other elements, not excluding the other elements.

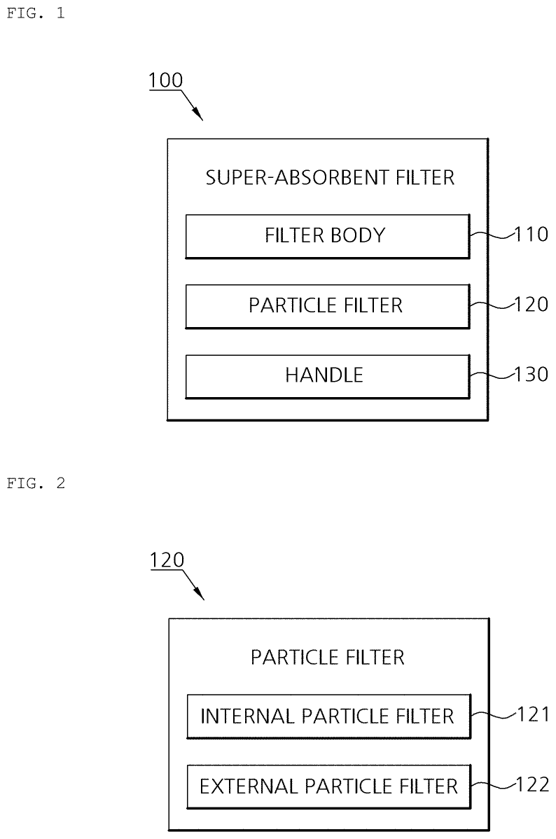

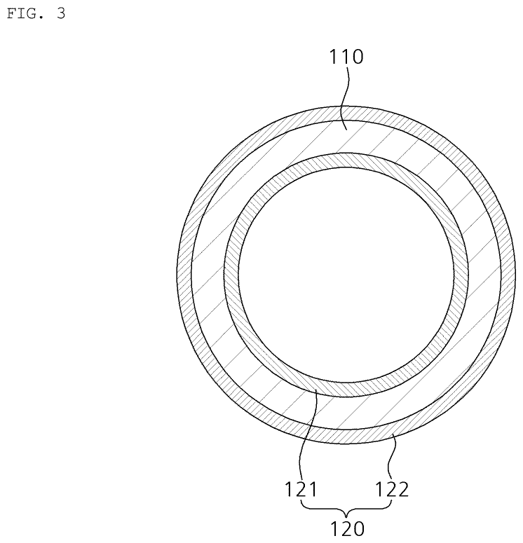

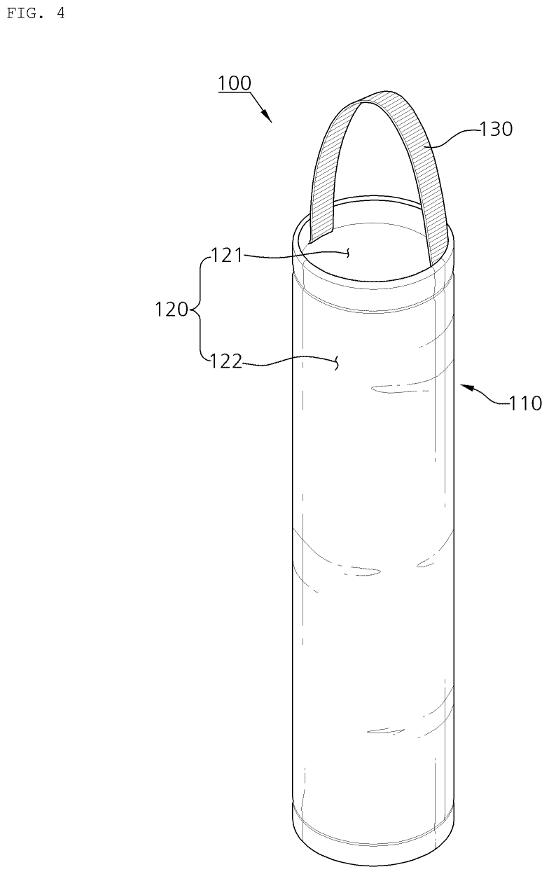

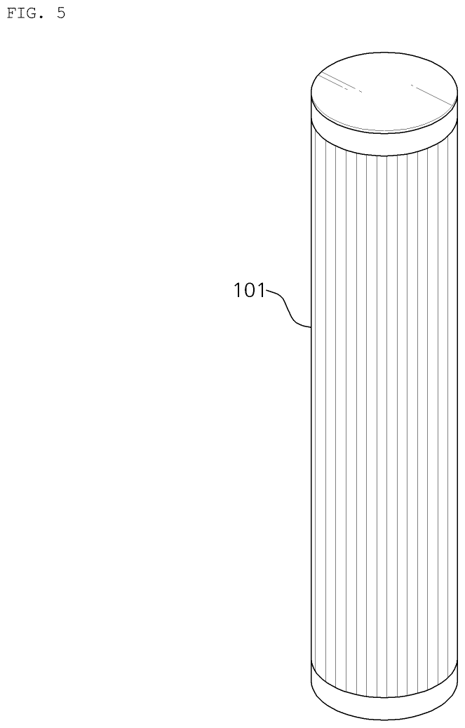

FIG. 1 is a functional block diagram illustrating a configuration of a super-absorbent filter capable of rapidly and economically removing moisture in a lubricant according to an embodiment of the present disclosure. FIG. 2 is a functional block diagram illustrating a configuration of a particle filter of the super-absorbent filter capable of rapidly and economically removing moisture in a lubricant according to an embodiment of the present disclosure. FIG. 3 is a schematic sectional view illustrating the configuration of the super-absorbent filter capable of rapidly and economically removing moisture in a lubricant according to an embodiment of the present disclosure. FIG. 4 is a schematic perspective view illustrating the configuration of the super-absorbent filter capable of rapidly and economically removing moisture in a lubricant according to an embodiment of the present disclosure. FIG. 5 is a schematic perspective view illustrating an existing standard particle filter to be covered with the super-absorbent filter capable of rapidly and economically removing moisture in a lubricant according to an embodiment of the present disclosure. As illustrated in FIGS. 1 to 5, according to an embodiment of the present disclosure, a super-absorbent filter 100 capable of rapidly and economically removing moisture in a lubricant may include a filter body 110 and a particle filter 120, and may further include a handle 130.

The filter body 110 is formed in a cylindrical shape by using a super-absorbent material so as to adsorb and remove free moisture in oil. Such a filter body 110 is formed in the cylindrical shape by using the super-absorbent material, and may be formed in a structure in which an upper portion and a lower portion thereof are opened. Here, as illustrated in FIG. 5, the filter body 110 may be famed in a structure that corresponds to a cylindrical shape of an existing standard particle filter 101 so that the filter body 110 is capable of being installed outside the existing standard particle filter 101 that is used in a power plant facility.

In addition, the filter body 110 may be formed of a super-absorbent nonwoven-fabric material that is to remove free moisture in oil. Such a filter body 110 may be formed in a cylindrical sock shape by being sewed using the super-absorbent material, that is, the super-absorbent nonwoven-fabric material.

In addition, since the filter body 110 is used by covering outside the existing standard particle filter 101, the filter body 110 may function to allow the super-absorbent filter 100 to be immediately applicable, without a need for an additional module housing, to the power plant facility that uses the existing standard particle filter 101.

The particle filter 120, by using an internal particle filter 121 and an external particle filter 122 that are respectively added and sewed to an internal portion and an external portion of the filter body 110 that is formed in the cylindrical shape, is configured to prevent loosening of the filter body 110 that may be caused by moisture adsorption of the super-absorbent material and to block contaminated particles in oil by assisting a core filter installed inside the super-absorbent filter 100. Such a particle filter 120 may be formed by being respectively added and sewed to the internal portion and the external portion of the filter body 110 formed in the cylindrical shape, and may be configured to prevent loosening of the filter body 110 that may be caused by moisture adsorption of the super-absorbent material and may have a pore size capable of blocking contaminated particles in oil.

As illustrated in FIG. 3, such a particle filter 120 may be formed of the internal particle filter 121 and the external particle filter 122 that are respectively added and sewed to the internal portion and the external portion of the filter body 110 that is formed in the cylindrical shape, and may have a pore size of 1 μm or 10 μm that is capable of capturing contaminated particles in oil. However, the pore size is not limited thereto, and the pore size may be 1 μm to 10 μm.

In addition, the particle filter 120, as the internal particle filter 121 and the external particle filter 122 that are respectively added and sewed to the internal portion and the external portion of the filter body 110, may function to prevent the super-absorbent nonwoven-fabric material from being detached.

At the super-absorbent filter 100 for removing free moisture in oil, the handle 130 is a configuration applied to any one of an upper portion and a lower portion of the cylindrical shape of the filter body 110. As illustrated in FIG. 4, such a handle 130 may be formed in a belt shape that is coupled by being sewed to the filter body 110.

In addition, the handle 130 may function to facilitate attachment and detachment of the super-absorbent filter 100 that is used by being applied to the power plant facility. That is, when the super-absorbent filter 100 is used in the power plant facility in which the super-absorbent filter 100 is applied in a state of covering outside the existing standard particle filter 101, the handle 130 may function to facilitate attachment and detachment of the super-absorbent filter 100.

The super-absorbent filter 100 having such structure, which can rapidly and economically remove moisture in a lubricant, may function as a sock-type moisture-adsorption-type moisture filter. That is, the super-absorbent filter 100 according to the present disclosure includes: the filter body 110 formed in the cylindrical shape by using the super-absorbent material so as to adsorb and remove free moisture in oil; the particle filter 120 provided with the internal particle filter 121 and the external particle filter 122 that are respectively added and sewed to the internal portion and the external portion of the filter body 110; and the handle 130, so that the super-absorbent filter 100 may function to rapidly remove free moisture accidentally introduced into the power plant facility in a short period of time.

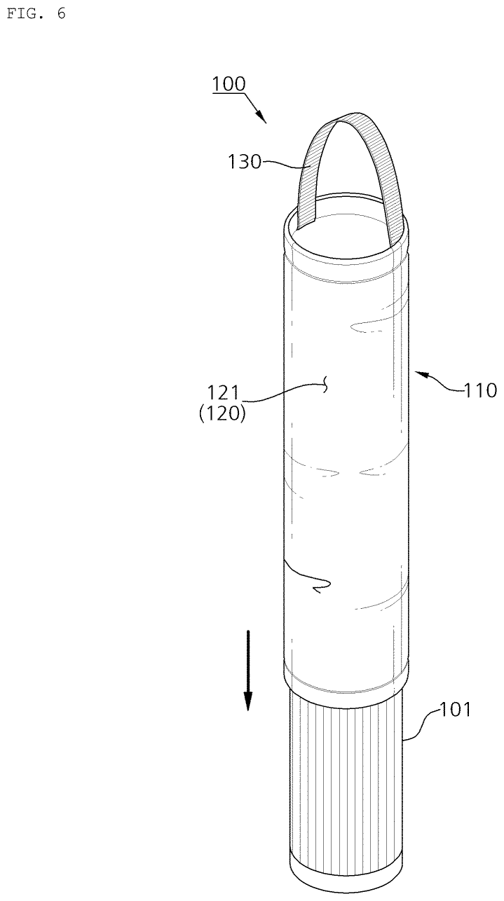

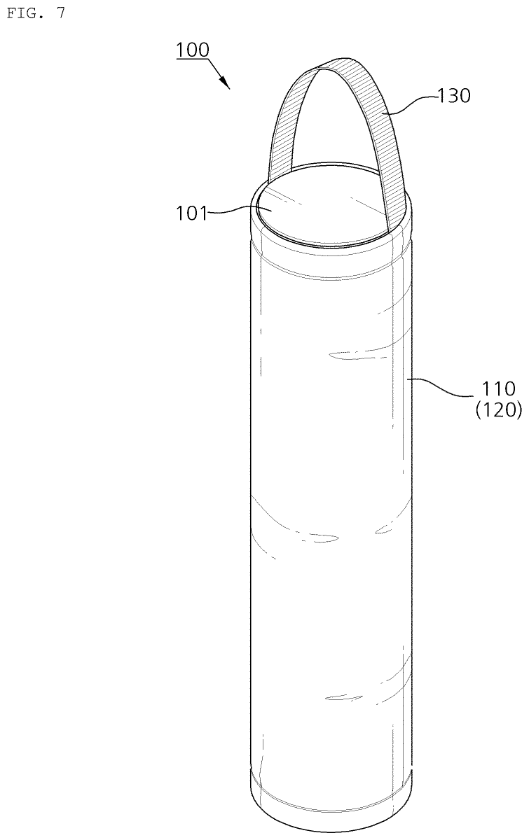

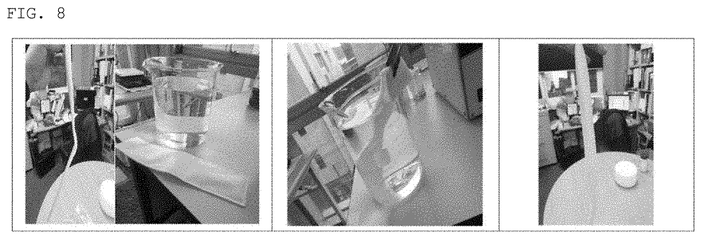

FIG. 6 is a view illustrating a process of covering the existing standard particle filter with the super-absorbent filter capable of rapidly and economically removing moisture in a lubricant according to an embodiment of the present disclosure. FIG. 7 is a view illustrating a combined state in which the existing standard particle filter is covered with the super-absorbent filter capable of rapidly and economically removing moisture in a lubricant according to an embodiment of the present disclosure.

FIG. 6 is a view illustrating a process that the existing standard particle filter 101 used in the power plant facility is covered with the super-absorbent filter 100, in which the super-absorbent filter 100 is formed of the particle filter 120 that is configured to capture contaminated particles in oil by using the internal particle filter 121 and the external particle filter 122 that are respectively added and sewed to the internal portion and the external portion of the filter body 110 that is formed in the cylindrical shape by using the super-absorbent material so as to adsorb and remove free moisture in oil.

FIG. 7 is a view illustrating a combined state in which the existing standard particle filter 101 used in the power plant facility is completely covered with the super-absorbent filter 100, in which the super-absorbent filter 100 is formed of the particle filter 120 that is configured to capture contaminated particles in oil by using the internal particle filter 121 and the external particle filter 122 that are respectively added and sewed to the internal portion and the external portion of the filter body 110 that is formed in the cylindrical shape by using the super-absorbent material so as to adsorb and remove free moisture in oil.

As such, according to the present disclosure, without using a separate additional module housing, the super-absorbent filter 100 capable of rapidly and economically removing moisture in a lubricant may be immediately applied to a facility that uses the existing standard particle filter 101 by completely combining the super-absorbent filter 100 with the existing standard particle filter 101 used in the power plant facility by covering. Accordingly, it is possible to further improve workability and efficiency according to the application of the super-absorbent filter 100.

FIG. 8 shows a procedure of a moisture absorption test of a super-absorbent material that is used as a filter body of the super-absorbent filter capable of rapidly and economically removing moisture in a lubricant according to an embodiment of the present disclosure. As illustrated in FIG. 8, a test of the super-absorbent nonwoven-fabric material of the filter body 110 is illustrated, in which the filter body 110 has the configuration of the super-absorbent filter 100 of the present disclosure capable of rapidly and economically removing moisture in a lubricant. That is, the super-absorbent nonwoven-fabric material for forming the filter body 110 and a cup containing 3 L of water was prepared, and the super-absorbent nonwoven-fabric material was added into the cup containing water. Then, the super-absorbent nonwoven-fabric material was taken out after a predetermined time elapsed, and a result that the super-absorbent nonwoven-fabric material absorbed about 300 mL of moisture was obtained.

As described above, according to an embodiment disclosure, the super-absorbent filter 100 capable of rapidly and economically removing moisture in a lubricant has a configuration including: the filter body 110 formed in the cylindrical shape by using the super-absorbent material so as to adsorb and remove free moisture in oil; and the particle filter 120 including the internal particle filter 121 and the external particle filter 122 that are respectively added and sewed to the internal portion and the external portion of the super-absorbent material so that preventing of loosening of the filter body 110 that may be caused by moisture adsorption of the super-absorbent material and blocking contaminated particles in oil by assisting a core filter installed inside the super-absorbent filter 100. Therefore, free moisture accidentally introduced into a lubrication system of a power plant facility may be rapidly removed in a short period of time. Especially, the super-absorbent filter 100 has a configuration including: the particle filter 120 provided with the internal particle filter 121 and the external particle filter 122 that are respectively added and sewed to the internal portion and the external portion of the filter body 110 formed in the cylindrical shape; and the handle 130 formed on the filter body 110. Therefore, capturing contaminated particles in an oil is capable by using the particle filter 121, attachment and detachment of the super-absorbent filter 100 applied to the power plant facility is facilitated by using the handle 130, and the workability and efficiency may be further improved accordingly.

In addition, the super-absorbent filter 100 has a configuration including: the filter body 110 formed in the cylindrical shape by using the super-absorbent material; the particle filter 120 capable of preventing of loosening of the filter body 110 that may be caused by moisture adsorption of the super-absorbent material and capable of blocking contaminated particles in oil by assisting a core filter installed inside the super-absorbent filter 100; and the sock-type moisture-adsorption-type moisture filter including the handle 130. Therefore, since the super-absorbent filter 100 is used by covering outside the existing standard particle filter 101, the super-absorbent filter 100 may be immediately applicable, without a need for a separate additional module housing, to the power plant facility that uses the existing standard particle filter 101, and the convenience of use may be further improved with a simple operation accordingly.

The present disclosure described above can be modified or applied in various ways by those of ordinary skill in the art to which the present disclosure pertains, and the scope of the technical spirit of the present disclosure should be defined by the appended claimed.

What is claimed is:

1. A super-absorbent filter capable of rapidly and economically removing moisture in a lubricant, the super-absorbent filter comprising:
a filter body (110) formed in a cylindrical shape by using a super-absorbent material so as to adsorb and remove free moisture in oil; and
a particle filter (120) comprising an internal particle filter (121) and an external particle filter (122) that are respectively added and sewed to an internal portion and an external portion of the filter body (110) that is formed in the cylindrical shape, the particle filter (120) being configured to prevent loosening of the filter body (110) that may be caused by moisture adsorption of the super-absorbent material and to block contaminated particles in the oil by assisting a core filter installed inside the super-absorbent filter.

2. The super-absorbent filter of claim 1, wherein the filter body (110) is formed in the cylindrical shape by using the super-absorbent material, and is configured in a structure in which an upper portion and a lower portion thereof are opened.

3. The super-absorbent filter of claim 1, wherein the filter body (110) is formed of a super-absorbent nonwoven-fabric material that is to remove free moisture in the oil.

4. The super-absorbent filter of claim 1, wherein the filter body (110) functions to allow the super-absorbent filter to be immediately applicable, without a need for an additional module housing, to a power plant facility that uses an existing standard particle filter (101) as the core filter since the filter body (110) is used by covering outside the existing standard particle filter (101).

5. The super-absorbent filter of claim 4, wherein the particle filter (120) is formed by being respectively added and sewed to the internal portion and the external portion of the filter body (110) formed in the cylindrical shape, and is configured to prevent loosening of the filter body (110) that may be caused by the moisture adsorption of the super-absorbent material and to have a pore size capable of blocking the contaminated particles in the oil.

6. The super-absorbent filter of claim 4, wherein the super-absorbent filter for removing free moisture in the oil functions as a sock-type moisture-adsorption-type moisture filter.

7. The super-absorbent filter of claim 6, further comprising:
a handle (130) applied to any one of an upper portion and a lower portion of the filter body (110) having the cylindrical shape.

8. The super-absorbent filter of claim 7, wherein the handle (130) functions to facilitate attachment and detachment of the super-absorbent filter when the super-absorbent filter is used in the power plant facility in which the super-absorbent filter is applied in a state of covering outside the existing standard particle filter (101).
